(19) United States
(12) Patent Application Publication
(10) Pub. No.: US 2010/0116157 A1
(43) Pub. Date: May 13, 2010

(54) METHOD AND DEVICE FOR APPLYING MEDIA TO FLAT SUBSTRATES

(75) Inventors: Franz Plachy, Brackenheim (DE); Oliver Stetter, Gemmingen (DE); Jakob Szekeresch, Schoemberg (DE)

Correspondence Address: SCULLY SCOTT MURPHY & PRESSER, PC, 400 GARDEN CITY PLAZA, SUITE 300, GARDEN CITY, NY, 11530, US

(73) Assignee: EKRA AUTOMATISIERUNGSSYSTEME GMBH, Boennigheim (DE)

(21) Appl. No.: 12/596,920

(22) PCT Filed: Apr. 22, 2008
(86) PCT No.: PCT/EP08/03219

§ 371 Date: Oct. 21, 2009

(30) Foreign Application Priority Data
Apr. 23, 2007 (DE) 10 2007 019 073.7

(51) Int. Cl. B41L 13/00; B41F 1/34

(52) U.S. Cl. 101/126; 101/485

(57) ABSTRACT

The invention relates to a device (1) for applying media to flat substrates (2), especially printed circuit boards, said device comprising a printing device for applying media to the substrate (2) during a printing method, an optical monitoring device for checking the arrangement and/or alignment of the substrate (2) in relation to the printing device, and a dispenser (10) for the additional application of media to the substrate (2). According to the invention, the dispenser (10) is fixed in relation to the optical monitoring device.

The present invention relates to a method and a device for applying media to flat substrates, in particular printed circuit boards. The media to be applied can be for example adhesive or a solder paste.

In order to provide flat substrates, in particular printed circuit boards, effectively with media, such as for example solder paste or adhesive, various methods have been developed in the past which render it possible to apply these media essentially simultaneously over almost the entire surface of the printed circuit board. In this connection, in particular so-called screen printing methods have become established methods, by means of which, with the aid of corresponding printing screens, printed circuit board tracks can be applied to the substrate in the respective desired pattern in a convenient manner.

The screen printing method therefore represents an inexpensive and effective solution for applying media to substrates. However, it has been demonstrated that it is frequently nit possible at least at some sites to apply the medium with the aid of the screen printing method in a sufficiently satisfactory manner. In this connection, such sites are in particular those sites which require more or less of the relevant medium than can be achieved using a screen printing screen.

In such cases, the medium must be applied individually or in spots, whereby generally so-called and already known dispensers are used for this purpose. Although it is possible with the aid of such devices to apply media in desired quantities at individual sites on a printed circuit board, this method is, however, less effective that the aforementioned screen printing method, which renders it less suitable for the general application of media to printed circuit boards. If it is intended that in addition to the screen printing method media is to be applied with the aid of a dispenser only at some specific sites, then the problem arises that the corresponding device for treating the substrate is of an extremely complex design.

Accordingly, the object of the present invention is to provide an improved option of applying media to substrates. In this connection, the option is to be created in particular to render possible also the additional application of media with the aid of a dispenser in a convenient and effective manner.

The object is achieved by means of a method in accordance with claim 1 and by means of a device in accordance with claim 6. Advantageous developments of the invention are subject of the dependent claims.

The present invention is fundamentally based on the idea that in addition to conventional printing onto the substrate, media are also to be applied additionally with the aid of a dispenser. In this connection, the devices which are already required for printing on the substrate are to be used in the most effective manner possible in order also to render possible the additional application of the media with the aid of the dispenser. In so doing, provision is particularly made to use an optical monitoring device which is already required for printing the substrate and with the aid of which the arrangement and correct alignment of the substrate with respect to the printing device are ensured, it being used to hold the dispenser in such a way that this dispenser is disposed in a fixed relation with respect to the optical monitoring device.

In particular, it can be provided that the dispenser is attached to a camera with the aid of which markings are monitored within the scope of the printing method, with the aid of said markings the correct arrangement and alignment of the substrate is established. Henceforth, it is now possible to use the camera axis, already provided, in order to place for example adhesive or solder deposits on the printed circuit board with the aid of the dispenser. In this connection, the dispenser can fully utilise the traversing range of the camera axis in order to reach all sites where additional dispensing is to be provided.

Accordingly, by virtue of the solution in accordance with the invention the total expenditure is considerably reduced since no separate device is required for applying the media with the aid of the dispenser. Moreover, the camera can also be used in order to ensure that the dispenser is arranged in the correct manner. In this way, finally, the overall quality and accuracy when applying media can be increased.

The invention is further explained hereinunder with reference to the attached drawing, in which:

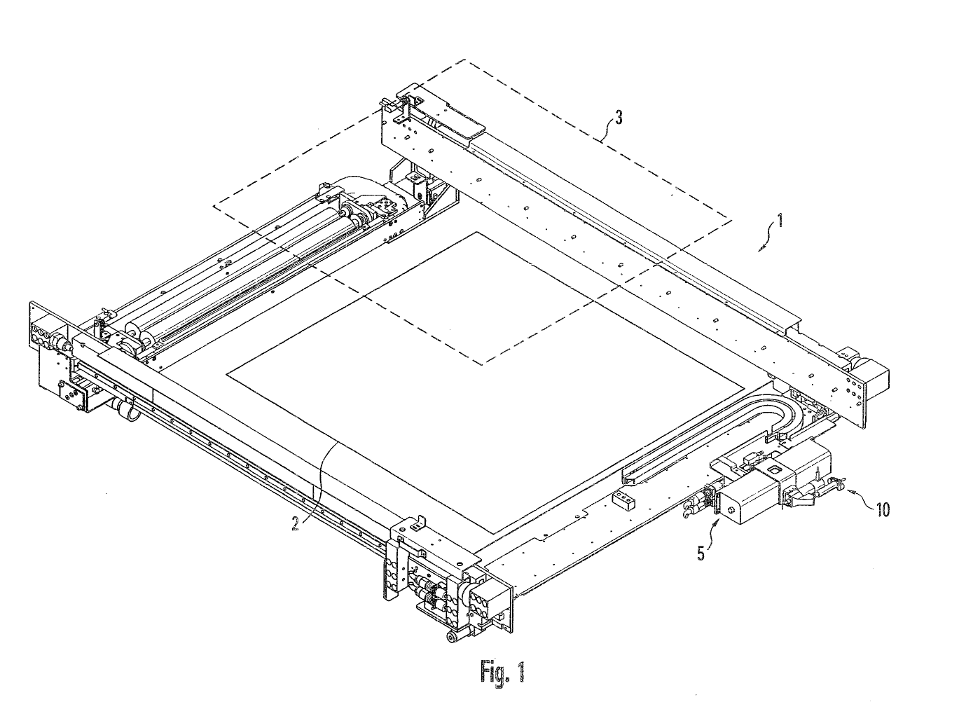

FIG. 1: shows the view of a device in accordance with the invention for applying media to a flat substrate;

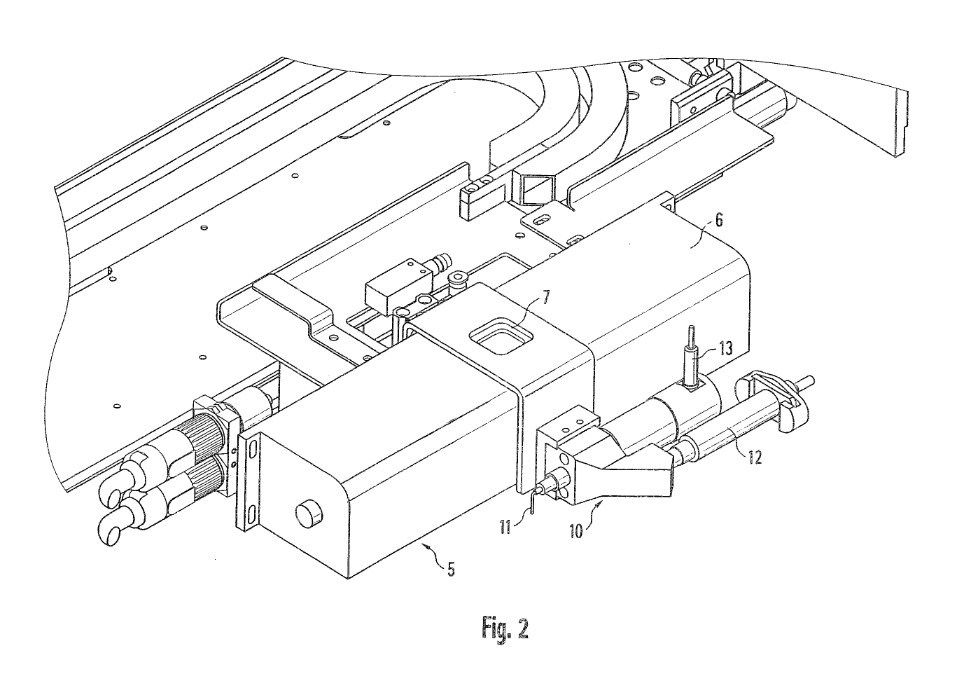

FIG. 2 shows an enlarged section of the view of FIG. 1.

FIG. 1 shows a device generally provided with the reference numeral 1 with the aid of which media, for example, adhesive or solder paste can be applied to a flat surface. The schematically illustrated substrate 2 is a printed circuit board which is to be provided in particular with printed circuit tracks.

In accordance with the present invention it is provided that in a first step a majority of the medium to be applied is first applied within the scope of a screen printing method. For this purpose, a screen printing screen 3 is schematically illustrated which is then to be arranged on the upperside of the printed circuit board 2 for the subsequent printing process. It is essential in this connection that the screen 3 is arranged and aligned with respect to the substrate 2 in the correct manner.

In a known manner the arrangement and alignment of the screen 3 with respect to the substrate 2 is monitored with the aid of an optical monitoring device, whose main component is a camera 5. As the enlarged illustrated in FIG. 2 shows, a camera window 7 is provided on the upper side of the housing 6 of the camera 5, with the aid of which the printing screen 3 located above the camera can be observed. In the same manner, a second camera window is also located on the underside of the housing 6 and is used to scan optically the printed circuit board 2 located underneath the camera 5. It is then possible with the aid of the two camera windows to detect markings provided on the screen 3 and on the printed circuit board 2, which markings are used to establish if the printed circuit board 2 is correctly arranged and aligned or if possibly a further corresponding correction is required. Once it is has been confirmed with the aid of the monitoring device that the arrangement is correct, the printing screen 3 is then lowered onto the printed circuit board 2 in order to initiate the printing process.

Moreover, in accordance with the invention a dispenser 10 is disposed on the camera housing 6 with the aid of a clamp 8, with the aid of said dispenser media can be applied onto the printed circuit board 2 in a further method step in spots and in addition to the screen printing method previously described. In the illustrated exemplified embodiment, the dispenser is a so-called screw dispenser 10 known per se, on whose front end is disposed a downwards directed needle 11 by means of which the medium located in a cartridge 12 is applied to the printed circuit board 2 with the aid of a motor 13. By way of example, the cartridge 12 can contain adhesive or solder paste.

The characteristic of the solution in accordance with the invention resides in the fact that the dispenser 10 is fixedly disposed on the camera 5. In this connection, a first advantage arises from the fact that the traversing ability of the camera 5, which is possible by virtue of the various components of the device 1 which are illustrated in FIG. 1 and are known per se, can also be used for correspondingly arranging the dispenser 10. The dispenser 10 can thus be moved in the plane of the printed circuit board 2 within the movement range of the camera 5 without having to provide additional mechanisms for this purpose. The cost of implementing a combined device for applying media with the aid of the screen printing method and with the aid of a dispenser is considerably reduced in this way.

A further advantage resides in the fact that the dispenser 10 is arranged in a known arrangement with respect to the camera 5, strictly speaking with regard to the camera window. This means that when subsequently additionally applying media with the aid of the dispenser 10, the camera 5 can also be used to ensure that the dispenser 10 is positioned in the correct manner. In this way, the accuracy is further improved when applying the media.

By virtue of the combination in accordance with the invention the precise and correct application of media on substrates is supported accordingly. Simultaneously the cost of implementing a corresponding device is reduced.

1. Method for applying media to flat substrates, in particular to printed circuit boards, comprising the following steps:
a) Arranging a substrate in a printing device,
b) Aligning the substrate with respect to the printing device with the aid of an optical monitoring device,
c) Applying media to the substrate with the aid of a printing method, and
d) Additional application of media to the substrate with the aid of a dispenser,
wherein the dispenser is arranged in a fixed relation with respect to the optical monitoring device.

2. Method as claimed in claim 1, wherein the media are applied in step (c) within the scope of a screen printing method, wherein with the aid of the optical monitoring device the arrangement and/or alignment of the substrate with respect to a printing screen of the printing device is checked.

3. Method as claimed in claim 1, wherein the optical monitoring device comprises a camera.

4. Method as claimed in claim 3, wherein the dispenser is attached to a housing of the camera.

5. Method as claimed in claim 1, wherein when additionally applying media with the aid of the dispenser the optical monitoring device is used for checking the position of the dispenser.

6. Device for applying media to flat substrates, in particular to printed circuit boards, comprising:
i) A printing device for applying media to the substrate within the scope of a printing method,
ii) An optical monitoring device for checking the arrangement and/or alignment of the substrate with respect to the printing device, and
iii) A dispenser for additionally applying media on the substrate, wherein the dispenser is arranged in a fixed relation with respect to the optical monitoring device.

7. Device as claimed in claim 6, characterised in that the printing device is designed for applying media within the scope of a screen printing method.

8. Device as claimed in claim 6, wherein the optical monitoring device comprises a camera.

9. Device as claimed in claim 8, wherein the dispenser is attached to a housing of the camera.
